(19) United States
(12) Patent Application Publication
(10) Pub. No.: US 2021/0147030 A1
(43) Pub. Date: May 20, 2021

(54) Bicycle with Sound Feedback and Method

(71) Applicant: VANMOOF B.V., Amsterdam (NL)

(72) Inventor: Ties Jonan Midas Carlier, Amsterdam (NL)

(21) Appl. No.: 17/045,400

(22) PCT Filed: Apr. 4, 2019
(86) PCT No.: PCT/NL2019/050204

§ 371 Date: Oct. 5, 2020

(30) Foreign Application Priority Data
Apr. 4, 2018 (NL) 2020717

(51) Int. Cl. B62J 50/22; B62J 43/30; B62J 45/10; B62J 45/20; B62J 43/10; B62J 50/20

(52) U.S. Cl. CPC B62J 50/22; B62J 43/30; B62J 50/20; B62J 45/20; B62J 43/10; B62J 45/10

(57) ABSTRACT

The present invention relates to a bicycle with feedback. The bicycle includes a tube assembly including a frame with mutually fixed tube elements and movable tube elements, such as steering tube and a handlebar, at least one subsystem for providing a respective function to the bicycle, and a control unit for functional interaction with the at least one subsystem . The control unit includes receiving means for receiving at least one status signal of the at least one subsystem, a processing means, such as a processing unit for processing the at least one status signal, and output means for outputting at least one output signal. The bicycle further includes a sound system, including a loudspeaker for outputting sound, a power supply, such as a battery, for providing power to the control unit and to the at least one subsystem. The sound system is arranged for outputting sound as a sound feedback based on the at least one status signal of the at least one subsystem.

### CROSS-REFERENCE TO RELATED APPLICATIONS

This application is the United States national phase of International Application No. PCT/NL2019/050204 filed Apr. 4, 2019, and claims priority to The Netherlands Patent Application No. 2020717 filed Apr. 4, 2018, the disclosures of which are hereby incorporated by reference in their entirety.

### BACKGROUND OF THE INVENTION

### Field of the Invention

The present invention relates to a bicycle with sound feedback. Furthermore, the present invention relates to a method for by a bicycle according to one or more of the preceding claims providing of at least one feedback.

### Description of Related Art

A bicycle is developed from a purely mechanical device towards a device with electromechanical and electronic components. In recent years, the bicycle has been provided with for example build in mobile communication technology for being able to track a bicycle by means of such mobile communication technology. Furthermore, the number of bicycles with electric motor is on the rise and has been known with a display for showing the speed. The present inventor has noticed disadvantages relating to displaying of the speed in this manner.

### SUMMARY OF THE INVENTION

In order to provide new possibilities, the present invention provides a bicycle with feedback, the bicycle comprising:

a tube assembly comprising a frame with mutually fixed tube elements and movable tube elements, such as steering tube and a handlebar,

at least one subsystem of the bicycle for providing of a respective function to the bicycle,

a control unit for functional interaction with the at least one subsystem of the bicycle, the control unit comprising:

receiving means for receiving of at least one status signal of the at least one subsystem,

processing means, such as comprising a processing unit, for processing of the at least one status signal, and

output means for outputting of at least one output signal, the bicycle further comprising:

a sound system, comprising a loudspeaker for outputting sound,

a power supply, such as a battery, for providing of power to the control unit and further preferably to the at least one subsystem, further preferably the sound system, wherein:

the sound system is arranged for outputting of sound as a sound feedback based on the at least one status signal of the at least one subsystem.

Such a bicycle according to the present invention thus provides an audible feedback based on signals originating from other subsystems of the bicycle. Because of this, it becomes possible for the user to receive information relating to such subsystems. Also other persons than the user can perceive such information. Because of this, it becomes for example possible to provide audible warnings to the user, but also to a person in the process of purloining a bicycle, or at least a person attempting the same.

According to a first preferred embodiment, the loudspeaker is arranged in the tube assembly. Such an arrangement in the tube assembly provides a high degree of robustness to the loudspeaker. A further advantage thereof is that perception of the sound provides an aspect of experiencing the sound as if it emanates from the bicycle. With this, and experience of a coupling between the bicycle and the sound is created.

Further preferably, the sound subsystem comprises an amplifier. With this, the volume can be controlled varying from a volume befitting a feedback to a person of the bicycle or a person next to the bicycle, or befitting a feedback that provides a feedback, such as an alarm, over a distance of meters, dozens of meters or hundreds of meters, at least being perceivable for the human ear or for a thereto arranged microphone.

According to a further preferred embodiment, at least one of the control unit, the at least one subsystem and the sound subsystem is arranged in a cassette, in which the cassette is preferably arrangeable in the tube assembly. With this, it is advantageously provided that a unit of the control unit and a number of subsystems and the sound system are arrangeable in a tube element of the bicycle as a whole. This is advantageous for aspects of assembly and repair. Also the durability of the whole of the elements arranged in the cassette is increased by the increased reliability of the mutual arrangement of the elements. In case such a cassette is arranged in a tube element of the bicycle, such arrangement contributes in a positive sense to the durability of the cassette and the contents thereof during the lifespan of the bicycle because it is protected by the same.

For the purpose of generating of a signal by the user of the bicycle, such as a bell signal or a horn signal, the bicycle further preferably comprises a subsystem wherein one of the at least one subsystem comprises a bell button or horn button that is preferably arranged in or at the handlebar. Because of this, the sound system according to the present invention is advantageously applied as a replacement for a traditional mechanical bell that is arranged on the handlebar. A bell of the bicycle is a vulnerable part. Because of the vulnerability of a bell on the handlebar, in the past it has been mounted to other parts of the bicycle. The sound providing function of the sound system provides advantageously a very robust solution to the old problem of the vulnerability of the bell, especially in case of an arrangement in a tube or other robust housing of the bicycle.

According to a further preferred embodiment, one of the at least one subsystem's is a sensor relating to the status of a lock blocking the functioning of the bicycle, such as a mechanical lock, an ignition lock function or an ignition lock for the control unit and/or an electric drive motor for the bicycle, further preferably wherein the lock, the ignition lock function and/or the ignition lock is arranged in the tube assembly, configured for providing of a status signal, such as for the purpose of a feedback, to the control unit. By means of such features according to these preferred embodiments, application of the sound feedback as alarm is embodied. It is for example possible to provide a sounding alarm in case the lock provides a status, such as a lock status, that the lock is locked and that the bicycle is being manipulated.

Further preferably, one of the at least one subsystem is an alternator, such as a front wheel alternator, such as a hub alternator, arranged for providing of a status signal, such as for the purpose of a feedback, to the control unit. Such an alternator provides as feature that in case of rotation of the wheel, in this case the front wheel, but the rear wheel is also envisaged, a signal is provided. A rotating alternator obviously provides a current. A combination of the signals that the lock is locked and still a wheel is rotating leads to an indication that an alarm is to be provided.

An alternative way of combining of signals leading to providing of the alarm relates to a preferred embodiment in which one of the at least one subsystem comprises a G force sensor or motion sensor, preferably arranged in the tube assembly, further preferably in a cassette according to the present invention. In case the lock indicates the status that it is locked, and the G force sensor or motion sensor indicates movement of the bicycle, this gives rise to an indication of alarm. It is envisioned that a cause for alarm arises in case of both rotation of the alternator and movement of the movement sensor, and the status of the lock that it is locked.

According to a further preferred embodiment, one of the at least one subsystem comprises a lighting subsystem comprising a front light and/or a rear light, preferably wherein the front light and/or the rear light is arranged in respective head ends of a top tube as part of the tube assembly, arranged for providing a status signal, such as for the purpose of a feedback, to the control unit. Such a preferred embodiment provides as advantage that besides alarm by means of noise alarm can be given based on other subsystems of the bicycle by means of this lighting. The notion hereby is that in case of a person purloining is moving along with a bicycle with a loud alarm and a linking lighting, preferably also with a rear wheel raced from the ground, this would present other persons with a sense of urgency. The prospect of such a sense of urgency alone would have to person intending to purloining refrain from such purloining or at least in case of understanding these ways of attracting attention by the person purloining would make this person stop performing the acts of purloining.

According to a further preferred embodiment, at least one of the at least one subsystem comprises a transceiver for a short distance network, such as Bluetooth, further preferably arranged in the tube assembly, further preferably in a cassette according to the invention. With this, it is advantageous that in this matter a feedback can be provided via the short distance network, such as Bluetooth, to a device, such as a phone. With this, the writer of the bicycle can be provided with a feedback fired his phone via an output device thereof.

For the purpose of a further feedback, at least one of the one subsystem preferably comprises a transceiver for a cellular network or mobile telephone network, preferably arranged in the tube assembly, further preferably in a cassette according the present invention. With this, it is advantageously provided to provide the feedback via such a network to a user of the bicycle or a tracking system for tracking of the bicycle. Further preferably, one of the at least one subsystem comprises a charging connector for connecting with the power supply, preferably comprising a USB connector and/or a coupling with a drive battery of the bicycle.

Further preferably, one of the at least one subsystem comprises the drive battery, preferably arranged in a tube element, and a drive engine for driving of the bicycle, arranged for providing a battery status signal, such as for the purpose of a feedback, to the control unit. With this, it is advantageously achieved that a sound feedback is provided able based on the battery status signal.

According to a further preferred embodiment, one of the at least one subsystem comprises a system for processing and/or storing of sound signals. A provided advantage of this preferred embodiment is that adapted sound signals are appliable, can be processed and can be stored. Because of this, it is e.g. further possible to change the search sound signals by means of a firmware update or software updates related to the control unit. Alternatively, it is hereby possible that the user adds, processes and stores own sound files, such as by means of the network connection for short range or intermediate range, such as by means of an application on the mobile phone or a file transfer.

According to a further preferred embodiment, one of the at least one subsystem comprises a light sensor, preferably arranged for recording ambient light, arranged for providing of the status signal, such as for the purpose of a feedback, to the control unit, wherein further preferably the light sensor is arranged in a front light or a rear light of the bicycle. Further preferably, the at least one subsystem comprises a temperature sensor, preferably arranged for recording and ambient temperature, arranged for providing a status signal, such as for the purpose of a feedback, to the control unit.

According to a further preferred embodiment, one of the at least one subsystem comprises a GPS receiver, arranged for providing of a status signal, such as for the purpose of a feedback, to the control unit.

According to a further preferred embodiment, the bicycle comprises a microphone for providing an ambient sound signal to the control unit for recording or relaying thereof. Such a preferred embodiment provides as an advantage that a sound feedback can be provided based on sound perceived from the environment.

Further preferably, the bicycle comprises processing means for detecting of the presence of sound, preferably comprising adjustment means for adjusting of a volume of the sound feedback to the detected ambient sound, wherein further preferably the volume of the sound feedback is positively related to the volume of the detected sound. With this, it is advantageous that the sound feedback from the bicycle may be perceived with substantially equal quality with several levels of sound in the surroundings.

Further preferably, the bicycle comprises a biometric sensor embodied as speech analysis means for recognizing speech and or a unique voice from the sound signal, such as that of a rightful owner of the bicycle, preferably for the purpose of assembling of a speech status signal, preferably comprising feedback means for the purpose of providing a sound feedback in case of recognition. With this, it is provided that the rightful user of the bicycle is recognizable as such by the biometric sensor and a feedback is thereby provided.

According to a further preferred embodiment, the bicycle comprises a speech analysis unit for recognizing of speech instructions as operating instructions for operating of the bicycle or the control unit thereof from the sound signal, preferably comprising feedback means for the purpose of providing a sound feedback in case of recognition. With this, it is advantageously realized to provide a sound feedback relating to the recognition of speech instructions.

Further preferably, the bicycle is further comprising a biometric sensor, preferably a fingerprint sensor for providing of a biometric sensor status signal, preferably comprising feedback means for the purpose of providing of a sound feedback in case of recognition. With this, it is advantageously achieved to provide a sound feedback in relation to the recognition by means of the biometric call sensor.

With such preferred embodiments, next to the sound feedback based on the recognition also a sound feedback based on nonrecognition is of importance. The user is thereby directly informed in relation to failing of the intended recognition. In such a way, a sound feedback is each time provided in a positive sense as well as a sound feedback in a negative sense.

A further aspect according to the present invention relates to a method for providing of at least one feedback from a bicycle according to one or more of the preceding claims, the method comprising steps of:

receiving of at least one status signal relating to a feedback by the control unit from one of the at least one subsystem,

assembling of at least one output signal relating to the feedback by the control unit based on at the at least one status signal,

in case the feedback relates to a sound feedback, providing of a sound output signal relating to the feedback to the sound subsystem.

By means of this aspect advantages are provided as indicated in combination with other aspects according to the present invention.

According to a preferred embodiment, the method comprises steps for, in case the feedback comprises a light feedback, comprising of a light output signal in relation to the feedback towards a display, the front light and/or the rear light. Because of this, a feedback is advantageously provided by means of for example a recognizable blinking. As further advantage, it is provided that such a light output signal directs the attention to works and also output sound feedback signal. Further preferably, the method comprises steps of:

receiving of a status signal as input for determining of an alarm status, and

assembling of an alarm settlement output signal based on the alarm status. Further preferably, steps are hereby provided of forming of an alarm output signal comprises steps of forming of a differentiated alarm sound output signal that is dependent of gradation of the alarm status, such as an alarm with a low intensity for warning of a person or an alarm with a high intensity for alarming of the environment.

Further preferably, steps are provided for:

receiving of a status of the alternator, such as indirectly via detecting of a charge current from the alternator via the control unit,

adjusting the alarm status based on the status of the alternator,

assembling of an adjusted alarm sound output signal based on the adjusted alarm status. Further preferably, steps are provided of assembling an alarm light output signal based on an alarm status or adjusted alarm status.

According to a further preferred embodiment, the method comprises steps of receiving a status of a bell button or horn button for providing a sound output signal related to a bell function or a horn function based on this status. With this, it is advantageously provided as an option to output a bell signal or a horn signal by means of the control unit and the sound system in a user-friendly manner.

A further aspect according to the present invention relates to a bicycle with sound feedback, the bicycle comprising:

a tube assembly comprising a frame with mutually fixed tube elements and movable tube elements, such as a steering pin and a handlebar,

a sound source for providing audible sound feedback of the bicycle,

a battery, for providing of power to the sound source,

wherein the sound source is actuable to output sound based on an input signal, the input signal being originating of at least one of:

a bell button or horn button providing a signal to the sound source for sending of a bell signal or horn signal,

a motion sensor for providing a signal to the sound source in case of motion of the bicycle,

wherein the sound source and/or the battery is arranged in one of the tube elements.

### BRIEF DESCRIPTION OF THE INVENTION

Further advantages, features and details of the present invention will be further elucidated on the basis of a description of one or more preferred embodiments with reference to the accompanying figures. Similar yet not necessarily identical parts of different preferred embodiments may be indicated with the same reference numerals.

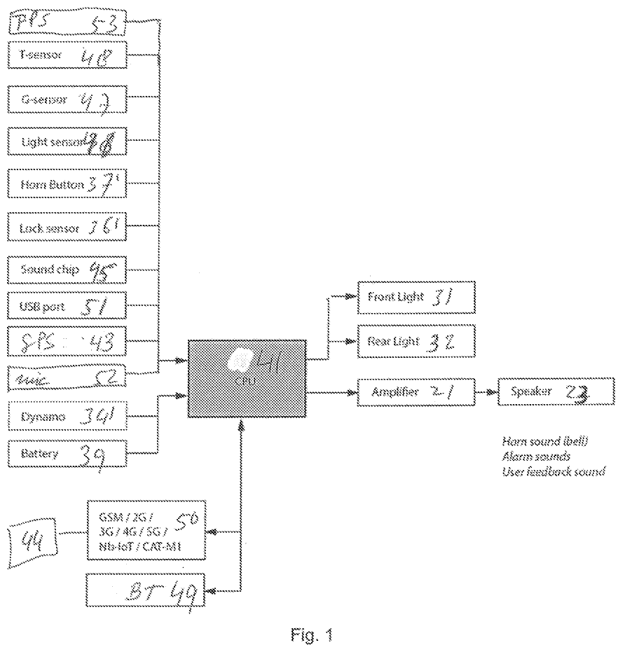

FIG. 1 relates to a schematic representation of subsystems of a bicycle with feedback according to a preferred embodiment according to the present invention.

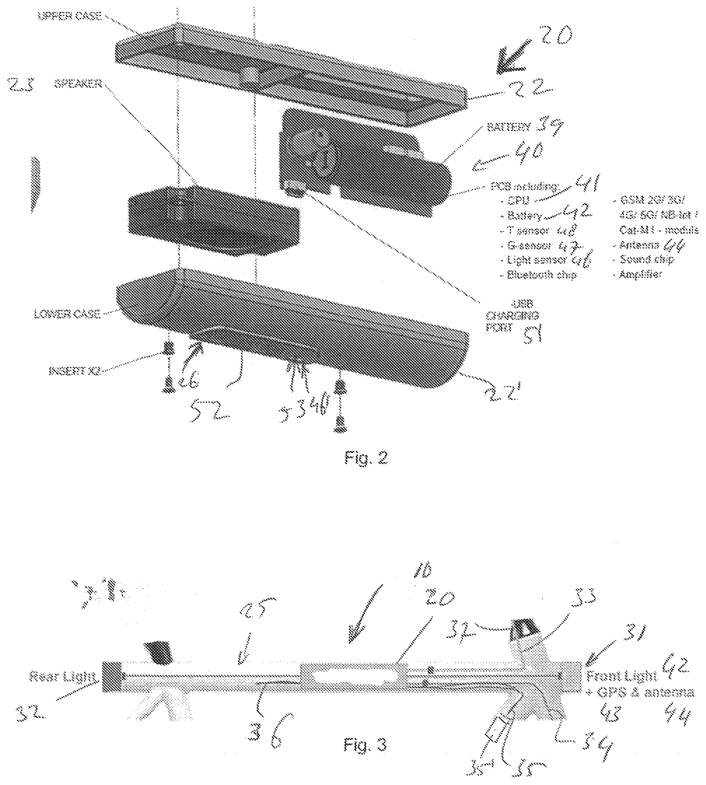

FIG. 2 relates to a schematic, exploded, representation of a cassette for arrangement thereof in a tube element according to a preferred embodiment according to the present invention.

FIG. 3 relates to a schematic representation of part of a tube assembly with their in a cassette and several subsystems according to a preferred embodiment according to the present invention.

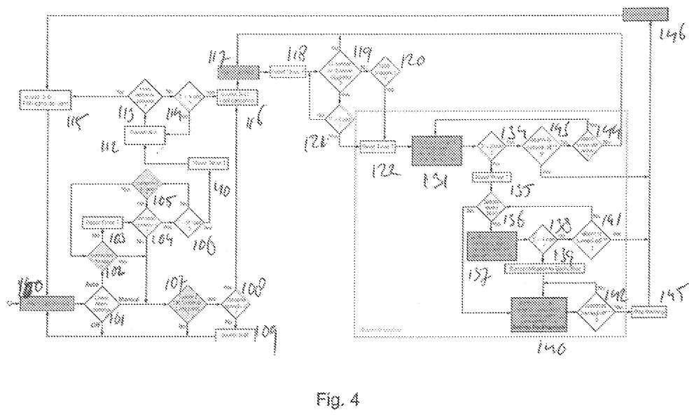

FIG. 4 relates to a flowchart of a preferred embodiment according to the present invention.

### DESCRIPTION OF THE INVENTION

A first preferred embodiment (FIG. 1) according to the present invention relates to a bicycle with feedback, of which a part of a tube assembly 10 thereof is shown in FIG. 3. The bicycle comprises a cassette 20 with their in a control unit 40. A part of the subsystems is arranged in the cassette 20 or in the control unit 40 thereof.

The cassette is built from two shell part, a bottom shell part 22′ and a top shell part 22. The loudspeaker 23 is arranged in the cassette as well as the control unit 40 of the bicycle.

An important advantage of the present invention is that by means of the loudspeaker 23 a sound feedback is provided for several functions of the bicycle and/or several operations of the user. Advantages thereof, that are further elucidated below by means of the description of respective elements of the bicycle, comprise a sound feedback when the user switches off the contact lock function or a physical lock, therewith activating a lock sensor; switching on or off of the light; moving of the bicycle while it is locked and the lock sensor is active, or when the contact lock function is switched off; plugging in or removing a charge cable in the USB port; confirming the speaking of a speech instruction as being received correctly; receiving of a Bluetooth signal of a mobile phone of a user or of a further Bluetooth device of a user, preferably which was preregistered or known to the bicycle; outputting of an alarm sound in case of an alarm condition of the bicycle; a sound feedback when the battery falls under a predetermined threshold charge.

The underside of the bottom shell parts 22′ has a curved surface for fitting within and also curved inner surface of top tube 25 of the bicycle. And optionally extending part of the bottom surface of shell part 22′ is arrangeable within a similarly shaped opening at the underside of the tube. Because of this, extending part 26 is free relative to the outside air for letting sound from the loudspeaker through a grid or openings. Furthermore, in a variant, a microphone 52 is provided for registering of sound from the outside of the bicycle. Furthermore, a fingerprint sensor 53 is provided for registering of a fingerprint of a user. In the present preferred embodiment, the fingerprint sensor 53 is provided in this extending part 26 of the shell part. Alternatively, such a fingerprint scanner is provided under or at the underside of the settle, or at the handlebar.

Depending on the embodiment, the control unit 40 comprises one or more of the following parts, a central processing unit, a battery 42, a temperature sensor 48, a motion sensor 47, a light sensor 46 receiving light through an opening in the tube, a Bluetooth sender receiver 49, a sender receiver 54 communication with mobile networks, such as 2G, 3G, 4G, 5G networks, preferably embodied as an NB-Iot of Cat-M1 module, an antenna 44, a sound processing module 45, and/or a sound amplifier 21 coupled to the loudspeaker 23. An alternative for the battery 42 is coupling with a drive battery 35′ in case of a bicycle with a drive motor. Alternatively, the battery 42 is chargeable from the alternator and/or from the optional drive battery when installed.

An exemplary provided subsystem relates to a temperature sensor 48 for providing of a status signal comprising a temperature reading from the temperature sensor 48. A further subsystem relates to a gravity sensor or G force sensor 47. By means of such G force sensor 47, a status signal is provided with respect to a movement of the bicycle. This status signal is of importance for determining whether the bicycle moves while it is not supposed to be moving, such when it is locked or when a contact lock function of the bicycle means that the bicycle is supposed to be switched off.

The light sensor 48 provides as status signal the amount of incident light. With this, it may be determined whether the bicycle is present in a light or dark environment. The bell button or horn button 37′ is connected by means of the cable 37 with the control unit. A status signal of the bell button or the horn button provides an operating signal of the user. With this, the user can switch off the alarm function by means of inputting of a predetermined code. It is furthermore provided to provide a bell signal or a horn signal by means of the loudspeaker 22.

The lock sensor 36's connected with the control unit by means of the cable 36. The lock sensor provides the condition of the lock by means of the status signal. To this end, the lock sensor is preferably embodied as a switch that is switchable by means of a mechanical element of the lock. Alternatively, it is provided that a contact lock status of the control system is applied in order to determine whether the alarm needs to be activated. Preferably in combination with information from the motion sensor, it is determined to this and that an initial alarm or a general alarm is to be given by means of sounds, light and/or signals by the network module.

A sound module 45 is provided for storage of signals for specific sounds. An initial alarm is preferably given by means of a sound that conveys a warning function, but that is not necessarily suitable for conveying an alarm over large distance. A general or alarming alarm is preferably given by means of a sound that is suitable for an alarming function, by means of the human hearing, over a larger distance, such as over several meters, to several dozens of meters, preferably several hundreds of meters. Furthermore, it is provided by means of the sound module 45 that the user of the bicycle can transfer personal feedback sounds to the sound module for outputting thereof in combination with a specific status signal. In this way, it is provided that the user can output a personalized bell sound from the loudspeaker when pressing the bell button or a predetermined code on the bell button.

A USB connector 51, such as a micro USB connector and/or a USB type C connector, is provided for a charging of the battery 39. The battery 39 is provided for provisioning the control unit with electrical energy as well as thereto coupled subsystems. The USB connector 51 serves the purpose of one of the possibilities to charge the same. Alternatively, in case the bicycle is an electrically driven bicycle or a bicycle with an electric assisting motor, it is provided that the battery is charged from a drive battery 35′ by means of a connecting cable 35. A further charging provision with respect to the battery 39 relates to charging by means of an alternator 34′ coupled by means of cable 34.

A network connection module 50 is provided for having a connection with a cellular telephone network. With this, the control unit is connected with external systems, such as an external server or a device of a user connectable with for instance the Internet, such as a mobile phone or computer.

A Bluetooth connection module 49 is provided for providing a short distance connection with a mobile telephone of a user. With this, the user operates several functions of the bicycle, such as the contact lock function. When the bicycle is in a locked status, the user sends a signal from the mobile telephone to the bicycle that the bicycle is to be brought from the locked status to an operational status. With this, the contact lock function is operated from the mobile phone of the user. This is either provided as an automatic function, such that the telephone and the bicycle automatically connect by means of the Bluetooth connection in order to switch the bicycle to the operational status based on the presence of the telephone. Alternatively, the user can activate this by means of an operation on the mobile telephone, such as by means of inputting a code.

According to preferred embodiments according to the present invention, a bicycle is provided with the capability of giving a feedback to occurrences by means of sound, which occurrences comprise operations of the user of the bicycle and operational feedback sounds related to states of the control unit of the bicycle and thereto coupled subsystems. Such feedback sounds related to bell sounds; warning sounds relating to an alarm function such as sounds 40 during and alarming alarm sounds; and operational feedback sounds such as a general positive feedback signal that is fed back such as a confirmation, a generally negative feedback signal such as indicating the opposite of a confirmation, a switch on the sound, such as of the control unit or a contact lock function, a switch of sound or standby confirmation, a switch on confirmation of the alarm, a switch of confirmation of the alarm, a confirmation sound of a lock switching to a locked state, a confirmation sound of a lock that is being unlocked, a sound of movement for moving through a menu, or a confirmation sound with inputting of a pin code for, for instance manually switching off of an alarm.

A tube element according to the preceding description is an element of the bicycle with a structural firmness such as of a tube, including elements as the frame, a front fork or rear fork, any supporting tube related thereto, the steering pin and/or handlebar. An arrangement of the actual loudspeaker in any of these said elements is intended with the description that a loudspeaker is available in a tube element of the bicycle.

According to an embodiment, for the purpose of the feedback, preferably in combination with the sound feedback based on the at least one status signal of the at least one subsystem optional. With this, a feedback by means of a lighting subsystem, such as the front light and/or the rear light, is provided as a primary feedback. Alternatively, a feedback by means of a further subsystem is provided, such as by means of an alarm subsystem with preferably a feedback by means of an alarm output signal, preferably via a network connection for short, intermediate or long-distance, such as a solar network connection system, such as a network for mobile telephony.

The present invention is described in the foregoing on the basis of preferred embodiments. Different aspects of different embodiments are expressly considered disclosed in combination with each other and in all combinations that on the basis of this document, when read by a skilled person of the area of skill, fall within the scope of the invention or are deemed to be read with the disclosure of this document. Further examples of the priority application are incorporated by means of a reference. These preferred embodiments are not limitative for the scope of protection of this document. The rights sought are defined in the appended claims.

1. A bicycle with feedback, the bicycle comprising:
a tube assembly comprising a frame with mutually fixed tube elements and movable tube elements, such as a steering tube and a handlebar,
at least one subsystem of the bicycle for providing a respective function to the bicycle,
a control unit for functional interaction with the at least one subsystem of the bicycle, the control unit comprises:
receiving means for receiving at least one status signal of the at least one subsystem,
processing means, such as a processing unit, for processing the at least one status signal, and
output means for outputting the at least one output signal, the bicycle further comprising:
a sound system, comprising a loudspeaker, for outputting sound,
a power supply, such as a battery, for providing power to the control unit and further preferably to the at least one subsystem, further preferably the sound system, wherein:
the sound system is arranged for outputting sound as a sound feedback based on the at least one status signal of the at least one subsystem.

2. The bicycle according to claim 1, wherein the loudspeaker is arranged in the tube assembly.

3. The bicycle according to claim 1, wherein the sound subsystem comprises an amplifier.

4. The bicycle according to claim 1, wherein the sound subsystem comprises an amplifier.

5. The bicycle according to claim 1, wherein one of the at least one subsystem comprises a bell button or horn button that is preferably arranged in or at the handlebar, arranged for providing of a status signal, such as for the purpose of a feedback, to the control unit.

6. The bicycle according to claim 1, wherein one of the at least one subsystem is a sensor relating to the status of a lock blocking the functioning of the bicycle, such as a mechanical lock, an ignition lock function or an ignition lock for the control unit and/or an electric drive motor for the bicycle, further preferably wherein the lock, the ignition lock function and/or the ignition lock is arranged in the tube assembly, configured for providing of a status signal, such as for the purpose of a feedback, to the control unit.

7. The bicycle according to claim 1, wherein one of the at least one subsystem is an alternator, such as a front wheel alternator, such as a hub alternator, arranged for providing of a status signal, such as for the purpose of a feedback, to the control unit.

8. The bicycle according to claim 1, wherein one of the at least one subsystem is a lighting subsystem comprising a front light and/or a rear light, preferably wherein the front light and/or the rear light is arranged in respective head ends of a top tube as part of the tube assembly, arranged for providing a status signal, such as for the purpose of a feedback, to the control unit.

9. The bicycle according to claim 1, wherein one of the at least one subsystem comprises a G force sensor or a motion sensor, preferably arranged in the tube assembly, further preferably in a cassette arranged for providing of a status signal, such as for the purpose of a feedback, to the control unit.

10. The bicycle according to claim 1, wherein one of the at least one subsystem comprises a transceiver for a short distance network, such as Bluetooth, further preferably arranged in the tube assembly, further preferably in a cassette.

11. The bicycle according to claim 1, wherein one of the at least one subsystem comprises a transceiver for a cellular network or mobile telephone network, preferably arranged in the tube assembly, further preferably in a cassette.

12. The bicycle according to claim 1, wherein one of the at least one subsystem comprises a charging connector for connecting with the power supply, preferably comprising a USB connector and or and/or a coupling with a drive battery of the bicycle.

13. The bicycle according to claim 1, wherein one of the at least one subsystem comprises a drive battery, preferably arranged in a tube element, and a drive engine for driving of the bicycle, arranged for providing a battery status signal, such as for the purpose of a feedback, to the control unit.

14. The bicycle according to claim 1, wherein one of the at least one subsystem comprises a system for processing and/or storing of sound signals.

15. The bicycle according to claim 1, wherein one of the at least one subsystem comprises a light sensor, preferably arranged for recording ambient light, arranged for providing of the status signal, such as for the purpose of a feedback, to the control unit, wherein further preferably the light sensor is arranged in a front light or a rear light of the bicycle.

16. The bicycle according to claim 1, wherein one of the at least one subsystem comprises a light sensor, preferably arranged for recording ambient light, arranged for providing of the status signal, such as for the purpose of a feedback, to the control unit, wherein further preferably the light sensor is arranged in a front light or a rear light of the bicycle.

17. The bicycle according to claim 1, wherein one of the at least one subsystem comprises a GPS receiver, arranged for providing of a status signal, such as for the purpose of a feedback, to the control unit.

18. The bicycle according to claim 1, comprising a microphone for providing an ambient sound signal to the control unit for recording or relaying thereof.

19. The bicycle according to claim 18, further comprising processing means for detecting of the presence of sound, preferably comprising adjustment means for adjusting of a volume of the sound feedback to the detected ambient sound, wherein further preferably the volume of the sound feedback is positively related to the volume of the detected sound.

20. The bicycle according to claim 18, further comprising a biometric sensor embodied as speech analysis means for recognizing speech and or a unique voice from the sound signal, such as that of a rightful owner of the bicycle, preferably for the purpose of assembling of a speech status signal, preferably comprising feedback means for the purpose of providing a sound feedback in case of recognition.

21. The bicycle according to claim 18, further comprising a speech analysis unit for recognizing of speech instructions as operating instructions for operating of the bicycle or the control unit thereof from the sound signal, preferably comprising feedback means for the purpose of providing a sound feedback in case of recognition.

22. The bicycle according to claim 1, further comprising a biometric sensor, preferably a fingerprint sensor for providing of a biometric sensor status signal, preferably comprising feedback means for the purpose of providing of a sound feedback in case of recognition.

23. A method for providing at least one feedback from a bicycle, the method comprising steps of:
receiving at least one status signal relating to a feedback by a control unit from one of at least one subsystem,
assembling at least one output signal relating to the feedback by the control unit based on the at least one status signal,
in case the feedback relates to a sound feedback, providing a sound output signal relating to the feedback to the sound subsystem.

24. The method according to claim 23, further comprising steps for, in case the feedback relates to a light feedback, providing a light output signal relating to the feedback to a display, a front light and/or a rear light.

25. The method according to claim 23, further comprising steps of:
receiving a status signal as input for determining an alarm status, and
assembling an alarm settlement output signal based on the alarm status.

26. The method according to claim 25, wherein the steps forming of an alarm output signal comprises steps of forming a differentiated alarm sound output signal that is dependent of gradation of the alarm status, such as an alarm with a low intensity for warning a person or an alarm with a high intensity for alarming the environment.

27. The method according to claim 23, further comprising steps of:
receiving a status of an alternator, such as indirectly via detecting a charge current from the alternator via the control unit,
adjusting the alarm status based on the status of the alternator, and
assembling an adjusted alarm sound output signal based on the adjusted alarm status.

28. The method according to claim 23, further comprising steps of assembling an alarm light output signal based on an alarm status or adjusted alarm status. The method according to claim 23, further comprising steps of assembling an alarm light output signal based on an alarm status or adjusted alarm status.

29. The method according to claim 23, further comprising steps of receiving a status of a bell button or horn button for providing a sound output signal related to a bell function or a horn function based on this status.

30. A bicycle with sound feedback, the bicycle comprising:
a tube assembly comprising a frame with mutually fixed tube elements and movable tube elements, such as a steering pin and a handlebar,
a sound source for providing audible sound feedback of the bicycle, and
a battery, for providing power to the sound source.
wherein the sound source is actuable to output sound based on an input signal, the input signal being originating at least at one of:
a bell button or horn button providing a signal to the sound source for sending a bell signal or horn signal, and
a motion sensor for providing a signal to the sound source in case of motion of the bicycle, and
wherein the sound source and/or the battery is arranged in one of the tube elements.
